(19) United States
(12) Patent Application Publication
(10) Pub. No.: US 2020/0335295 A1
(43) Pub. Date: Oct. 22, 2020

(54) HIGH-VOLTAGE FUSE

(71) Applicant: XIAMEN SET ELECTRONICS CO., LTD, Xiamen (CN)

(72) Inventor: Yaoxiang HONG, Xiamen (CN)

(73) Assignee: XIAMEN SET ELECTRONICS CO., LTD, Xiamen (CN)

(21) Appl. No.: 16/958,792

(22) PCT Filed: Mar. 26, 2019
(86) PCT No.: PCT/CN2019/079720

§ 371 Date: Jun. 29, 2020

(30) Foreign Application Priority Data
Apr. 3, 2018 (CN) 201820460110.X

(51) Int. Cl. H01H 85/143; H01M 2/34; H01H 85/165; H01H 85/38

(52) U.S. Cl. CPC H01H 85/143; H01M 2/348; H01M 2220/20; H01H 85/38; H01M 2200/103; H01H 85/165

(57) ABSTRACT

A high-voltage fuse includes a temperature fuse device and a high-voltage breaking device that are connected in parallel, wherein the high-voltage breaking device includes a fuse link, and the fuse link is an n-shaped structure with parallel segments at both ends thereof; and a resistance value of the temperature fuse device is lower than a resistance value of the fuse link, and a melting point of the temperature fuse device is lower than a melting point of the fuse link. The high-voltage fuse can realize an over-temperature fusing function. Due to the n-shaped fuse link, the electric arc may be cut off quickly to perform high-voltage breaking and protect the safety of the circuitry.

### CROSS REFERENCE TO THE RELATED APPLICATIONS

This application is the national phase entry of International Application No. PCT/CN2019/079720, filed on Mar. 26, 2019, which is based upon and claims priority to Chinese Patent Application No. 201820460110.X, filed on Apr. 3, 2018, the entire contents of which are incorporated herein by reference.

### TECHNICAL FIELD

The present invention relates to a fuse, and in particular to a high-voltage fuse.

### BACKGROUND

Since 2014, the electric vehicle market in China has entered a period of rapid development. In 2017, China's top-down promotion of new energy vehicles reached an unprecedented level, and a large-scale promotion was performed across the country. On Jan. 11, 2018, the China Association of Automobile Manufacturers held a press conference on automobile production and sales data of December 2017, and it announced that the annual cumulative production and sales amounts of new energy vehicles in 2017 are 794,000 and 777,000, respectively, and their year-on-year increases are 53.8% and 53.3%, respectively.

Batteries are vital components in new energy vehicles. Since SONY Company commercialized lithium-ion batteries in 1991, lithium batteries have moved from the field of electronic products to the field of power tools and also to the field of electric vehicles and energy storage, and have become main bodies of power battery products. Due to the advantages of high energy density, large rate charge and discharge performance and long cycle life, the lithium batteries become the first choice of electric energy storage carriers.

On the other hand, the electrolyte used in the lithium battery is an organic liquid that becomes viscous or even condensed at low temperatures, which reduces the efficiency of lithium batteries at low temperatures. Related research shows that the optimal discharge temperature of the lithium battery used in the new energy vehicle is between 30-35° C. When the ambient temperature decreases, the internal resistance of the storage battery increases, the discharge current of the battery decreases, and the effective usable capacity also becomes smaller. When the temperature is below −10° C., charging the battery will greatly reduce the battery's lifetime. Therefore, preheating the lithium battery before starting has become a common practice in the high-end electric vehicle industry.

The heating system is configured to meet the normal use of the battery in a low-temperature environment and consists of a heating element and a circuit. The battery voltage of China's new energy vehicles is higher than that of foreign countries. It has the following advantages. Firstly, the energy consumption loss is small, and secondly, the drive power of the motor is high. Therefore, increasing the voltage will be a development direction. In the case of the same output power, increasing the battery pack voltage can reduce the operating current, which requires higher performance for peripheral components. High-voltage battery packs also have higher requirements for circuit protection components in the heating system.

A Chinese patent No. 201420230161.5 discloses a high-voltage direct current (DC) temperature fuse, which can reach a high-voltage DC thermal protection component of 15 A and 450 Vdc. However, the battery packs of mainstream domestic vehicle manufacturers all have voltage settings of above 500 Vdc, so high-voltage DC protection components are needed in the market.

### SUMMARY

In order to solve the above existing problems, an objective of the present invention is to provide a high-voltage fuse, which can effectively perform protection under high-voltage conditions.

The objective of the present invention is achieved by the following technical solutions.

A high-voltage fuse, including a temperature fuse device and a high-voltage breaking device, wherein the temperature fuse device and the high-voltage breaking device are connected in parallel; the high-voltage breaking device includes a fuse link, and the fuse link is an n-shaped structure with parallel segments at both ends thereof; and a resistance value of the temperature fuse device is lower than a resistance value of the fuse link, and a melting point of the temperature fuse device is lower than a melting point of the fuse link. The fuse link used commonly includes an alloy wire. Because the resistance value and melting point of the high-voltage breaking device are higher than those of the temperature fuse device, when a rated current is passed, most of the current-carrying capacity is mainly realized by the temperature fuse device. At the instant when the temperature fuse device achieves over-temperature fusing, the high-voltage breaking device remains in an on-state, and the current flows through the high-voltage breaking device. The current-carrying capacity of the alloy wire of the high-voltage breaking device is set to be less than the rated current, and when an over-current passe through the fuse link, the heat generation of the fuse link gradually increases, and the fuse link fuses by itself. An electric arc is inevitably generated during the breaking of the fuse link. Due to the arrangement of parallel segments formed by the n-shaped structure, a high electric field strength exists, electrons repel each other, and the electric arc is elongated to accelerate the recombination and diffusion of free electrons and positive ions, which can realize a protection behavior of rapid breaking.

Further, the high-voltage breaking device further includes a breaking insulating stopper provided between the parallel segments of the fuse link. The breaking insulating stopper is arranged to increase the creepage distance and improve the insulation tolerance.

Further, the temperature fuse device includes a fusible alloy, wherein a surface of the fusible alloy is coated with a fluxing agent.

Further, a plurality of fusible alloys are connected in parallel. Because the too thick fusible alloy is not conducive to shrinking, the cross-sectional area of the fusible alloy is designed according to different current-carrying capacity, and the fusible alloy is divided into a plurality of parallel structures.

Further, the temperature fuse device includes at least two fusible alloys, one of which has a lower resistivity and melting point than the other fusible alloys.

Further, the fusible alloy is an n-shaped structure with parallel segments at both ends thereof, and a fusing insulating stopper is provided between the parallel segments. In this way, the creepage distance and electrical clearance between the two electrodes are increased to improve the insulation withstand voltage capability.

Further, a left electrode piece and a right electrode piece are provided, and one end of the temperature fuse device and the high-voltage breaking device is connected to the left electrode piece, and the other end of the temperature fuse device and the high-voltage breaking device is connected to the right electrode piece; an insulating casing is further provided, and the temperature fuse device and the high-voltage breaking device are packaged in the insulating casing; and the left electrode piece and the right electrode piece are extended out of the insulating casing as lead-out ends.

Further, the insulating casing, the left electrode piece, the right electrode piece, and the high-voltage breaking device enclose a breaking cavity, and the insulating casing, the left electrode piece, the right electrode piece and the temperature fuse device enclose a fusing cavity. The two cavities separate from each other to ensure that the components in the cavities do not affect each other and are not contaminated.

Further, the breaking cavity is filled with an arc-extinguishing medium. The arc-extinguishing media used commonly is applicable, and the quartz sand is preferred in the present invention. In high-voltage applications, the electric arc is easy to cause gasification and expansion of the alloy wire. The arc-extinguishing medium can absorb the impact of gasification and cover the transmission path of the electric arc, which is beneficial to the insulation withstand voltage of the open circuit point.

Further, each of the left electrode piece and the right electrode piece includes an L-shaped connecting portion, and the L-shaped connecting portion and the temperature fuse device are vertically welded. In this way, the shrinkage surface of the temperature fuse device is increased to make the shrinkage more thorough, and the electrical clearance between the two electrode planes is increased.

The advantages of the present invention include at least as follows.

The high-voltage fuse of the present invention can realize an over-temperature fusing function. Due to the n-shaped structure of the fuse link, the electric arc may be cut off quickly to perform high-voltage breaking and protect the safety of the circuitry.

The above description is only an overview of the technical solutions of the present invention. In order to understand the technical means of the present invention more clearly, it can be implemented in accordance with the content of the description, and in order to make the above and other objectives, features and advantages of the present invention more obvious and understandable, the specific embodiments of the present invention are specifically exemplified below.

### BRIEF DESCRIPTION OF THE DRAWINGS

The present invention is further described below in conjunction with the following accompanying drawings.

FIG. 1 is a circuit schematic diagram of a high-voltage fuse according to the present invention;

FIG. 2 is an exploded schematic diagram of a high-voltage fuse according to Embodiment 1 of the present invention;

FIG. 3 is a schematic longitudinal sectional diagram of the high-voltage fuse according to Embodiment 1 of the present invention;

FIG. 4 is a schematic cross-sectional diagram of a temperature fuse device of the high-voltage fuse according to Embodiment 1 of the present invention;

FIG. 5 is a schematic cross-sectional diagram of a high-voltage breaking device of the high-voltage fuse according to Embodiment 1 of the present invention; and

FIG. 6 is an exploded schematic diagram of a high-voltage fuse according to Embodiment 2 of the present invention.

### IN THE FIGURES

101 Temperature fuse device

102 High-voltage breaking device

103 First pin

104 Second pin

201 Outer casing

201a Fusing cavity

201b Breaking cavity

202 Cover plate

203 Breaking insulating stopper

204 Right electrode piece

204a Right L-shaped connecting portion

204b Right-side hole

205 Fusible alloy

206 Left electrode piece

206a Left L-shaped connecting portion

206b Left-side hole

207 Alloy wire

208 Fluxing agent

209 Quartz sand

210 Epoxy resin

211 Right soldering tin

212 Left soldering tin

301 Outer casing

302 Cover plate

302a Breaking insulating stopper

303 Breaking insulating stopper

304 Right electrode piece

304a Right boss

304b Right-side hole

305 Fusible alloy

306 Left electrode piece

306a Left boss

306b Left-side hole

307 Alloy wire

### DETAILED DESCRIPTION OF THE EMBODIMENTS

The present invention is specifically described below with reference to the accompanying drawings.

### Embodiment 1

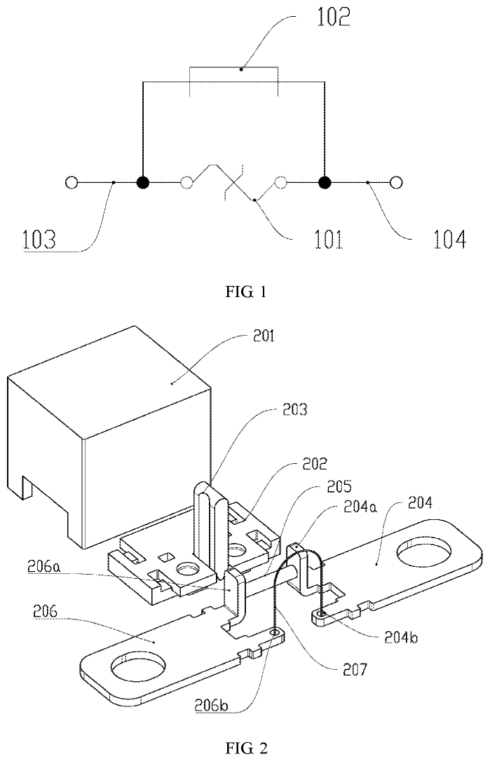

As shown in FIG. 1, the temperature fuse device 101 and the high-voltage breaking device 102 are connected in parallel, wherein the temperature fuse device 101 performs an over-temperature fusing function, and the high-voltage breaking device 102 includes an n-shaped alloy wire to perform a high-voltage breaking function. Moreover, the first pin 103 and the second pin 104 are connected to two parallel points and lead out, respectively. Because the resistance value and melting point of the high-voltage breaking device 102 are higher than those of the temperature fuse device 101, when a rated current is passed, most of the current-carrying capacity is mainly realized by the temperature fuse device 101. At an instant when the temperature fuse device 101 achieves over-temperature fusing, the high-voltage breaking device 102 remains in an on-state, and the current flows through the high-voltage breaking device 102. The current carrying capacity of the alloy wire of the high-voltage breaking device 102 is set to be less than the rated current, and when the current passes through the alloy wire, with the increase of heat, the alloy wire fuses by itself, and an arc inevitably occurs during the breaking process. Due to the arrangement of parallel segments formed by the n-shaped structure, a high electric field strength exists, electrons repel each other, and an electric arc is elongated to accelerate the recombination and diffusion of free electrons and positive ions, which can quickly cut off the electric arc, perform high-voltage breaking, and protect the safety of the circuitry.

### Embodiment 2

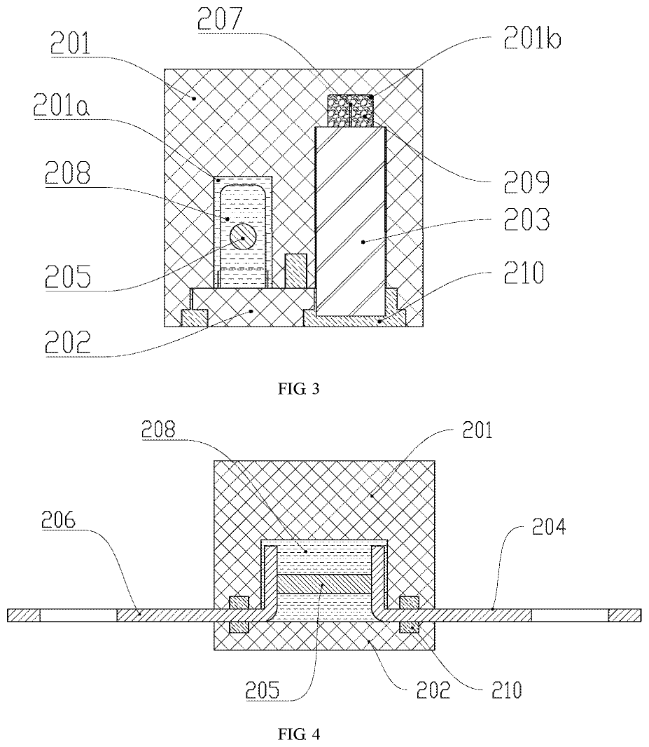

As shown in FIGS. 2, 3, 4, and 5, two separate cavities, i.e. the fusing cavity 201a and the breaking cavity 201b, are formed by the outer casing 201, the cover plate 202 and the epoxy resin 210.

The right electrode piece 204 and the left electrode piece 206 are provided. The right electrode piece 204 and the left electrode piece 206 are in a mirror image relationship, and are provided at an interval directly opposite to each other, and are extended out of the outer casing 201 as lead-out ends. The right L-shaped connecting portion 204a and the right-side hole 204b are provided at one end of the right electrode piece 204, respectively, and correspondingly, the left L-shaped connecting portion 206a and the left-side hole 206b are provided at one end of the left electrode piece 206, respectively.

In the fusing cavity 201a, the fusible alloy 205 coated with the fluxing agent 208 is provided between the right L-shaped connecting portion 204a and the left L-shaped connecting portion 206a to form the electrical connection between the right electrode piece 204, the fusible alloy 205 and the left electrode piece 206, thereby constituting a temperature fuse device.

In the breaking cavity 201b, the n-shaped alloy wire 207 is provided between the right-side hole 204b and the left-side hole 206b. One end of the alloy wire 207 is fixed to the right electrode piece 204 through the right soldering tin 211, and the other end of the alloy wire 207 is fixed to the left electrode piece 206 through the left soldering tin 212, thereby forming the electrical connection between the right electrode piece 204, the alloy wire 207 and the left electrode piece 206, and constituting the main body of the high-voltage breaking device. In the breaking cavity 201b, the quartz sand 209 is filled around the alloy wire 207. The breaking insulating stopper 203 is provided between parallel segments of the n-shaped alloy wire 207 to increase the electrical clearance and creepage distance between the right electrode piece 204 and the left electrode piece 206 after the alloy wire 207 is disconnected.

When applied to protection of a new energy passenger car heater, the high-voltage fuse is connected in series with a heating circuit. Under normal conditions, the fusible alloy 205 assumes the main current-carrying function. When the relay of the heating circuit fails and the heating circuit cannot be disconnected, the heater continues to operate and the temperature rises abnormally. When the temperature reaches the softening temperature of the fluxing agent 208, the fluxing agent 208 changes from a solid state to a liquid state and starts to activate the surface oxide layer of the fusible alloy 205. When the temperature reaches the fusing temperature of the fusible alloy 205, the fusible alloy 205 shrinks and moves toward the right L-shaped connecting portion 204a and the left L-shaped connecting portion 206a under the tension of the fluxing agent 208, thereby cutting off the temperature fuse device. All of the current flows through the alloy wire 207 and exceeds the current-carrying capacity of the alloy wire 207. The alloy wire 207 promotes the increase of heat due to its own high resistance to cause the temperature to reach the melting point of the alloy wire 207, and then the alloy wire 207 fuses by itself. An electric arc is inevitably generated during the breaking process. Due to the arrangement of the parallel segments formed by the n-shaped structure, a high electric field strength exists, electrons repel each other, the electric arc is elongated to accelerate the recombination and diffusion of free electrons and positive ions,. Additionally, the quartz sand 209 can absorb the impact of arc gasification and separate the electric arc. Therefore, the electric arc is quickly cut off, the high-voltage breaking is performed, and the safety of the circuitry is protected.

### Embodiment 3

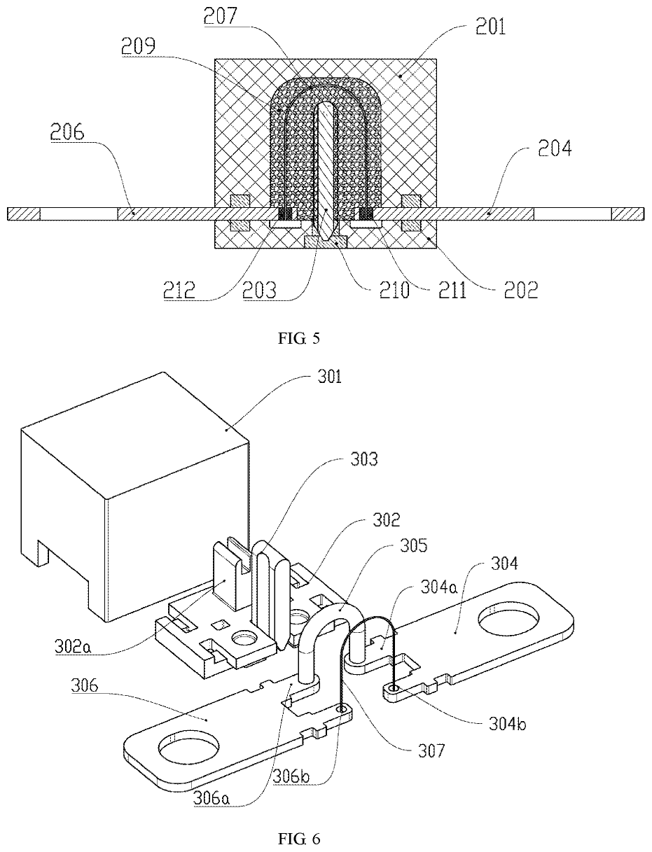

As shown in FIG. 6, two separate cavities formed by the outer casing 301 and the cover plate 302 are provided with the right electrode piece 304 and the left electrode piece 306, respectively. The right electrode piece 304 and the left electrode piece 306 are in a mirror image relationship, and are provided at an interval directly opposite to each other, and the right electrode piece 304 and the left electrode piece 306 are exposed to the outer casing 301 from opposite ends. The right boss 304a and a right-side hole 304b are provided at one end of the right electrode piece 304, respectively, and the left boss 306a and correspondingly, the left-side hole 306b are provided at one end of the left electrode piece 306, respectively.

In one of the cavities of the outer casing 301, the n-shaped fusible alloy 305 coated with the fluxing agent is provided between the right boss 304a and the left boss 306a to form the electrical connection between the right electrode piece 304, the fusible alloy 305 and the left electrode piece 206, thereby constituting a temperature fuse device. Moreover, in this cavity, the fusing insulating stopper 302a is provided on the cover plate 302, thereby increasing the creepage distance and electrical clearance after the fusible alloy 305 is disconnected.

In another one of the cavities of the outer casing 301, the n-shaped alloy wire 307 is provided between the right-side hole 304b and the left-side hole 306b. One end of the alloy wire 307 is fixed to the right-side hole 304b on the right electrode piece 304 through the soldering tin, and the other end of the alloy wire 307 is fixed to the left-side hole 306b on the left electrode piece 306 through the soldering tin, thereby forming the electrical connection between the right electrode piece 304, the alloy wire 307 and the left electrode piece 306, and constituting the main body of the high-voltage breaking device. Moreover, in this cavity, the quartz sand is filled around the alloy wire 307. The breaking insulating stopper 303 is provided between parallel segments of the n-shaped alloy wire 307 to increase the electrical clearance and creepage distance between the right electrode piece 304 and the left electrode piece 306 after the alloy wire 307 is disconnected.

When applied to protection of an electric bus heater, the high-voltage fuse is connected in series with a heating circuit. Under normal conditions, the fusible alloy 305 assumes the main current-carrying function. When the relay of the heating circuit fails and the heating circuit cannot be disconnected, the heater continues to operate and the temperature rises abnormally. When the temperature reaches the softening temperature of the fluxing agent, the fluxing agent changes from a solid state to a liquid state and starts to activate the surface oxide layer of the fusible alloy 305. When the temperature reaches the fusing temperature of the fusible alloy 305, the fusible alloy 305 shrinks and moves toward the right boss 304a and the left boss 306a on both sides under the tension of the fluxing agent, thereby cutting off the temperature fuse device. All of the current flows through the alloy wire 307 and exceeds the current-carrying capacity of the alloy wire 307. The alloy wire 207 promotes the increase of heat due to its own high resistance, to cause the temperature reach the melting point of the alloy wire 307, and then the alloy wire 207 fuses by itself. An electric arc is inevitably generated during the breaking process. Due to the arrangement of the parallel segments formed by the n-shaped structure, a high electric field strength exists, electrons repel each other, the electric arc is elongated to accelerate the recombination and diffusion of free electrons and positive ions. Additionally, the quartz sand can absorb the impact of arc gasification and separate the electric arc. Therefore, the electric arc is quickly cut off, the high-voltage breaking is performed, and the safety of the circuitry is protected.

It should be understood that the embodiments of the present invention are merely examples for clearly illustrating the present invention, and are not intended to limit the present invention. Although the present invention has been described in detail with reference to the embodiments, for those skilled in the art, it is still possible to make other changes or modifications in different forms or equivalently replace some of the technical features on the basis of the above description. However, any modification, equivalent replacement, improvement, etc. made within the spirit and principles of the present invention shall fall within the scope of protection of the present invention.

What is claimed is:

1. A high-voltage fuse, comprising a temperature fuse device and a high-voltage breaking device, wherein the temperature fuse device and the high-voltage breaking device are connected in parallel; the high-voltage breaking device comprises a fuse link, the fuse link is an n-shaped structure, and parallel segments of the fuse link are arranged at both ends of the fuse link, respectively;
and a resistance value of the temperature fuse device is lower than a resistance value of the fuse link, and a melting point of the temperature fuse device is lower than a melting point of the fuse link.

2. The high-voltage fuse according to claim 1, wherein, the high-voltage breaking device further comprises a breaking insulating stopper provided between the parallel segments of the fuse link.

3. The high-voltage fuse according to claim 1, wherein, the temperature fuse device comprises a plurality of fusible alloys, and a surface of each fusible alloy of the plurality of fusible alloys is coated with a fluxing agent.

4. The high-voltage fuse according to claim 3, wherein,-a the plurality of fusible alloys are connected in parallel.

5. The high-voltage fuse according to claim 4, wherein, one fusible alloy of the plurality of fusible alloys has a lowest resistivity and a lowest melting point in the plurality of fusible alloys.

6. The high-voltage fuse according to claim 3, wherein, the each fusible alloy is an n-shaped structure, parallel segments of the each fusible alloy are arranged at both ends of the each fusible alloy, respectively, and a fusing insulating stopper is provided between the parallel segments of the each fusible alloy.

7. The high-voltage fuse according to claim 1, further comprising a left electrode piece, a right electrode piece and an insulating casing, wherein, a first end of the temperature fuse device is connected to the left electrode piece, and a second end of the temperature fuse device is connected to the right electrode piece; a first end of the high-voltage breaking device is connected to the left electrode piece, and a second end of the high-voltage breaking device is connected to the right electrode piece; the temperature fuse device and the high-voltage breaking device are packaged in the insulating casing; and the left electrode piece and the right electrode piece are extended out of the insulating casing as lead-out ends.

8. The high-voltage fuse according to claim 7, wherein, the insulating casing, the left electrode piece, the right electrode piece and the high-voltage breaking device enclose a breaking cavity, and the insulating casing, the left electrode piece, the right electrode piece and the temperature fuse device enclose a fusing cavity.

9. The high-voltage fuse according to claim 8, wherein, the breaking cavity is filled with an arc-extinguishing medium.

10. The high-voltage fuse according to any one of claim 7, wherein, each of the left electrode piece and the right electrode piece comprises an L-shaped connecting portion, and the L-shaped connecting portion and the temperature fuse device are vertically welded.

11. The high-voltage fuse according to claim 4, wherein, the each fusible alloy is an n-shaped structure, parallel segments of the each fusible alloy are arranged at both ends of the fusible alloy, respectively, and a fusing insulating stopper is provided between the parallel segments of the each fusible alloy.

12. The high-voltage fuse according to claim 5, wherein, the each fusible alloy is an n-shaped structure, parallel segments of the each fusible alloy are arranged at both ends of the fusible alloy, respectively, and a fusing insulating stopper is provided between the parallel segments of the each fusible alloy.

13. The high-voltage fuse according to claim 8, wherein, each of the left electrode piece and the right electrode piece comprises an L-shaped connecting portion, and the L-shaped connecting portion and the temperature fuse device are vertically welded.

14. The high-voltage fuse according to claim 9, wherein, each of the left electrode piece and the right electrode piece comprises an L-shaped connecting portion, and the L-shaped connecting portion and the temperature fuse device are vertically welded.

15. The high-voltage fuse according to claim 7, wherein, the right electrode piece and the left electrode piece are in a mirror image relationship.
